(19) United States
(12) Patent Application Publication
(10) Pub. No.: US 2008/0156596 A1
(43) Pub. Date: Jul. 3, 2008

(54) Sprag and bearing system

(75) Inventors: David P. Smith, Reddick, IL (US); Eric R. Lauterbach, Joliet, IL (US); Daniel T. Mather, Lockport, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/646,537

(22) Filed: Dec. 28, 2006

(51) Int. Cl. F16D 41/06; F16C 19/00; F16D 63/00

(52) U.S. Cl. 188/82.8; 192/41 A; 384/456

(57) ABSTRACT

A sprag and bearing system including a sprag is disclosed. The sprag includes an integral body having an oblong cross sectional circumference at least one actuator configured to selectively rotate the body about an axis in a first direction. The sprag also includes at least one spring configured to bias the body to rotate about the axis in a second direction.

### CROSS REFERENCED APPLICATIONS

This application is related to co-pending application titled “Hydraulic Motor” filed Dec. 28, 2006, and having a patent application Ser. No. ______.

### TECHNICAL FIELD

The present disclosure relates to sprags and bearings and, more particularly, to a sprag and bearing system.

### BACKGROUND

Sprags and similar devices are often used to transfer rotary movement from a drive member, e.g., an inner race, and a reaction member, e.g., an outer race in a first direction, e.g., clockwise, and to not transfer rotary movement therebetween in a second direction opposite the first direction, e.g., counter-clockwise. Often bearings are interspaced between the sprags to rotatably support the inner and outer races and assist the races in rotating when the sprags do not transfer rotary movement therebetween. Typically, a sprag includes a partially arcuate outer surface that is biased into frictional engagement with an inclined surface associated with either or both of an outer surface of the inner race and/or an inner surface of the outer race. Upon movement of the drive member in the biasing direction, the sprag becomes wedged between and substantially locks the drive and reaction members together. Upon movement of the drive member in the non-biasing direction, the sprag overcomes the biasing force, moves away from the includes surface, and establishes sliding contact between the drive and reaction members. Bearings typically include rotary bearings in contact with the outer surface of the inner race and the inner surface of the outer race and help to reduce the friction between respective races and the sprags in sliding contact therewith. Thus, when a sprag substantially locks the drive and reaction members together, torque applied to the drive member is transferred to the reaction member, and when the sprag establishes sliding contact between the drive and reaction members, torque applied to the drive member is not transferred to the reaction member.

U.S. Pat. No. 5,482,144 (“the '144 patent”) issued to Vranish discloses a three dimensional roller locking sprag. The sprag of the '144 patent includes two pairs of curved peripheral side surfaces which respectively contact a pair of mutual diverging side wall surfaces of a groove disposed within a drive member and a reaction member. The sprag of the '144 patent substantially locks the drive and reaction members together for torque transfer therebetween in a first direction and establishes a sliding contact therebetween in a second direction.

Although the sprag of the '144 patent may transfer torque from the drive member to the reaction member in a first direction, movement of the drive member is required to lock and thus transfer torque to the reaction member. That is, the sprag of the '144 patent is a passively actuated sprag. Additionally, the frictional engagement of the sprag of the '144 patent in a substantially locked position may be insufficiently small to transfer relatively large torques between the drive and reaction members.

The present disclosure is directed to overcoming one or more of the shortcomings set forth above.

### SUMMARY OF THE INVENTION

In one aspect, the present disclosure is directed to a sprag. The sprag includes an integral body having an oblong cross sectional circumference at least one actuator configured to selectively rotate the body about an axis in a first direction. The sprag also includes at least one spring configured to bias the body to rotate about the axis in a second direction.

In another aspect, the present disclosure is directed to a system. The system includes an inner race member and an outer race member. The inner race member is spaced apart from the outer race member. The system also includes a plurality of sprags disposed between the inner and outer race members. The plurality of sprags are configured to selectively and substantially lock the inner and outer race members together as a function of pressurized fluid being selectively supplied to the plurality of sprags.

### BRIEF DESCRIPTION OF THE DRAWINGS

FIG. 1 is a diagrammatic illustration of a exemplary motor in accordance with the present disclosure;

FIG. 2 is a diagrammatic illustration of an exemplary toothed wheel of the motor of FIG. 1;

FIG. 3 is a diagrammatic side-view illustration of an exemplary sprag and bearing of the toothed wheel of FIG. 2;

FIG. 4 is a diagrammatic sectional illustration of the sprag of FIG. 3;

FIG. 5 is a diagrammatic sectional illustration of the bearing of FIG. 2; and

FIG. 6 is a diagrammatic illustration of the motor of FIG. 1 operatively connected to an output.

### DETAILED DESCRIPTION

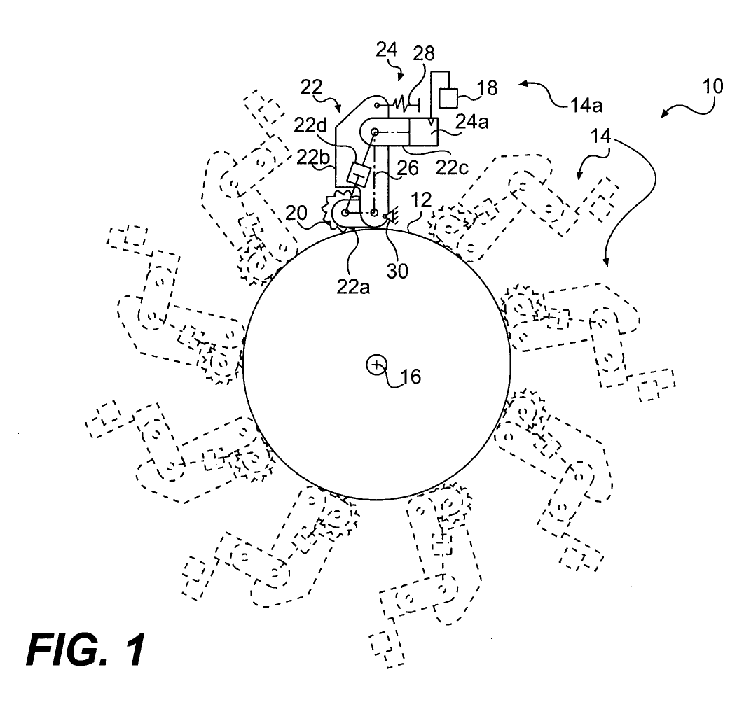

FIG. 1 illustrates an exemplary motor 10. Motor 10 may include an output wheel 12 and a plurality of displacement assemblies 14. Motor 10 may also include a longitudinal axis 16 about which output wheel 12 may be configured to rotate. Each of displacement assemblies 14 may be disposed radially outward of output wheel 12 and may be configured to selectively engage an outer circumference thereof. It is contemplated that the outer circumference of output wheel 12 may have a profiled shape, such as, for example, a saw-tooth pattern, a ratchet tooth pattern, and/or any other profile known in the art. It is also contemplated that output wheel 12 may be configured to transfer rotational movement thereof to one or more mechanical devices, such as, for example, an axle, a gear train, a wheel hub, a sprocket, and/or other mechanical device known in the art and may be operatively connected thereto by, for example, a fixed connection, an enmeshed toothed connection, a belt connection, and/or other connection methods known in the art. It is further contemplated that motor 10 may include any quantity of displacement assemblies 14.

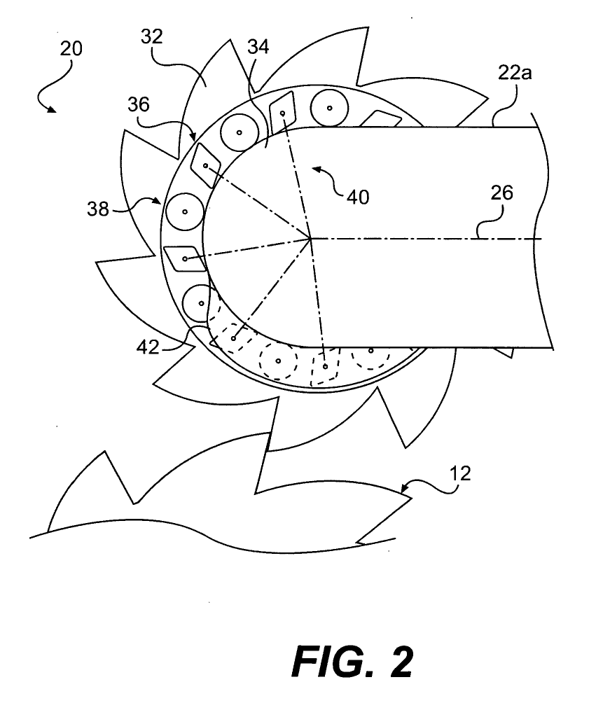

First displacement assembly 14a may include a toothed wheel 20, a linkage 22, a first hydraulic actuator 24, and a first fluid path 26. Toothed wheel 20 may include a wheel rotatably supported by linkage 22 and may be configured to selectively engage an outer circumference of output wheel 12. Toothed wheel 20 may have a profiled outer circumference complementary to the profile of the outer circumference of output wheel 12. Toothed wheel 20 is further described below with reference to FIG. 2. The description herein of first displacement assembly 14a is equally applicable to each of displacement assemblies 14.

First hydraulic actuator 24 may include a piston-cylinder arrangement and may be configured to selectively impart a first linear motion to linkage 22 as a function of pressurized fluid selectively supplied to a first fluid chamber 24a. First hydraulic actuator 24 may also be configured to selectively impart a second linear motion, substantially opposite in direction to the first linear motion, as a function of pressurized fluid selectively drained from first fluid chamber 24a. Pressurized fluid may be selectively supplied to and drained from first fluid chamber 24a by a hydraulic system 18. For example, hydraulic system 18 may include a source of pressurized fluid (not illustrated), a fluid reservoir (not illustrated), and a least one valve (not illustrated) configured to selectively fluidly connect the first chamber of first hydraulic actuator 24 with either the source of pressurized fluid or the fluid reservoir. First displacement assembly 14a may also include a spring 28 operatively connected to linkage 22, first hydraulic actuator 24, or other suitable element of first displacement assembly 14a, to bias first hydraulic actuator 24 in the second direction, i.e., opposite the direction in which first hydraulic actuator 24 may be biased as a function of pressurized fluid selectively supplied to first fluid chamber 24a. It is contemplated that spring 28 may have one end thereof fixed relative to axis 16. It is also contemplated that the source of pressurized fluid and/or the fluid reservoir of hydraulic system 18 may include an accumulator. It is further contemplated that hydraulic system 18 may be dedicated to first displacement assembly 14a, i.e., one of displacement assemblies 14 or, alternatively, hydraulic system 18 may be operatively connected to each of displacement assemblies 14.

Linkage 22 may include a first link 22a, a second link 22b, and a third link 22c. It is contemplated that second link 22b may be configured to pivot about a pivot point 30 fixed relative to axis 16 as a function of the first and second linear motions imparted thereto by first hydraulic actuator 24. First link 22a may include a first connection point operatively connected to toothed wheel 20 and configured to rotatably support toothed wheel 20 thereon. First link 22a may also include a second connection point operatively connected to a first end of second link 22b. Third link 22c may be operatively connected at a first connection point to first hydraulic actuator 24 and configured to reciprocate substantially therewith. Third link 22c may also include a second connection point operatively connected to a second end of second link 22b. Second link 22b may be operatively connected to pivot 30 and may be configured to rotate about pivot 30 as a function of the first and second movements of first hydraulic actuator 24 and third link 22c. It is contemplated that the first and second connection points of second link 22b may be connected to one another via any connection known in the art allowing relative movement therebetween, such as, for example, a pinned connection. It is also contemplated that second link 22b may be connected to pivot 30 at any location, such as, for example, a location disposed opposite the second connection point of link 22b with respect to the first connection point of link 22b, a location disposed opposite the first connection point of link 22b with respect to the second connection point, or a location disposed between the first and second connection points of link 22b. It if further contemplated that first, second, third links 22a-c may each include any conventional link element known in the art, such as, for example, single link plate, a plurality of link plates operatively connected together, interleaved link plates, and/or combinations thereof.

Linkage 22 may also include second hydraulic actuator 22d. Second hydraulic actuator 22d may be operatively connected between the second end of second link 22b and the first end of first link 22 and may be configured to provide a linear movement therebetween. Second hydraulic actuator 22d may include a piston-cylinder arrangement with at least a first chamber therein configured to selectively receive pressurized fluid via a first fluid path 26. First fluid path 26 may extend from the first fluid chamber 24a, through third link 22c, through second link 22b, and through first link 22a. First fluid path 26 may include one or more passageways, e.g., channels or conduits, extending through first, second, third links 22a-c that may be connected to one another at respective connection points of first, second, third links 22a-c via any suitable fluid connection, such as, for example, a partial or full circumferential groove about a pinned connection.

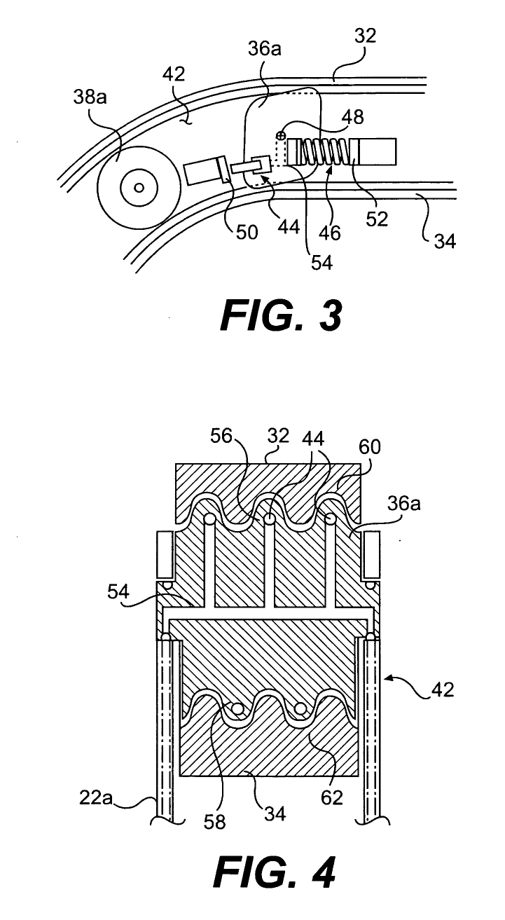

FIG. 2 illustrates an exemplary toothed wheel 20. Toothed wheel 20 may further include an outer race 32, an inner race 34, a plurality of sprags 36, and a plurality of bearings 38. Outer race 32 may include the profiled circumference of toothed wheel 20 and may be radially disposed outwardly of and rotatable with respect to inner race 34. Inner race 34 may be operatively, e.g., fixedly, connected to first link 22a and first link 22a may include a second fluid path 40. Plurality of sprags 36 and plurality of bearings 38 may both be disposed radially between outer race 32 and inner race 34 and may be configured to support outer race 32 with respect to inner race 34 and selectively allow rotation of outer race 32 with respect to inner race 34. Second fluid path 40 may include a plurality include one or more passageways, e.g., channels or conduits, extending through first link 22a extending radially toward each of plurality of sprags 36 and may be configured to fluidly connect first fluid path 26 therewith. It is contemplated that inner race 34 may or may not be integral with first link 22a. Toothed wheel 20 may include a bearing cage 42 that may or may not be integral with inner race 34 and/or first link 22a configured to rotatably support plurality of sprags 36 and plurality of bearings 38. Bearing cage 42 is further described below with reference to FIGS. 3 and 4.

FIG. 3, illustrates an exemplary sprag 36a. Sprag 36a may include a plurality of actuators 44 and a plurality of springs 46 (only one actuator and one spring are illustrated in FIG. 3). Plurality of actuators 44 may each include a piston-cylinder arrangement configured to extend as a function of pressurized fluid selectively supplied thereto. Plurality of actuators 44 may affect sprag 36a to rotate in a first direction with respect to bearing cage 42 and about a sprag axis 48. Bearing cage 42 may include a first tab 50 extending therefrom and configured to resist movement of plurality of actuators 44 and affect rotation of sprag 36a about sprag axis 48 in a first direction. Bearing cage 42 may also include a second tab 52 extending therefrom and configured to resist movement of plurality of springs 46 and bias sprag 36a about sprag axis 48 in a second direction opposite the first direction. Extension of plurality of actuators 44 may overcome the bias of plurality of springs 46 when pressurized fluid is selectively supplied thereto and the bias of plurality of springs 46 may affect rotation of sprag 36a when pressurized fluid is not selectively supplied to plurality of actuators 42. Pressurized fluid may be selectively supplied to plurality of actuators 44 via a third fluid path 54 configured to be in fluid communication with second fluid path 40. Third fluid path 54 is further described below with reference to FIG. 4.

Sprag 36a may be oblong in shape including a first or long dimension. The extension of the plurality of actuators 44 may rotate sprag 36a about sprag axis 48 in the first direction and affect the long dimension to fixedly engage outer and inner races 32, 34 and substantially lock together outer and inner races 32, 34. Sprag 36a may also include a second or short dimension. The bias of plurality of springs 46 may rotate sprag 36a about sprag axis 48 in the second direction to affect sprag 36a to not fixedly engage outer and inner races 32, 24 and not substantially lock together outer and inner races 32, 34. It is contemplated that the bearing cage 42 may include a plurality passageways therein, e.g., channels or conduits, as part of second fluid path 40 that may be configured to fluidly communicate pressurized fluid toward third fluid path 54. It is also contemplated that the passageways of bearing cage 42 may be connected to third fluid path 54 via any suitable fluid connection, such as, for example, a partial or full circumferential groove about a pinned connection between bearing cage 42 and sprag 36a.

As illustrated in FIG. 4, sprag 36a may also include one or more ridges 56, 58 on an outer surface thereof. Ridges 56, 58 may be complementary in shape and configured to selectively engage grooves 60, 62 disposed on an inner surface of outer race 32 and on an outer surface of inner race 34, respectively. It is contemplated that ridges 56, 58 and grooves 60, 62 may include any quantity and/or shape, e.g., arcuate, triangular, square, or rectangularly stepped, and may be regularly or irregularly spaced with respect to sprag axis 48. It is also contemplated that ridges 58 may be staggered with respect to ridges 55 according to any amount of offset therebetween.

Third fluid path 54 may configured to fluidly communicate pressurized fluid from second fluid path 40 to each of plurality of actuators 44. Third fluid path 54 may or may not be symmetrical with respect to a longitudinal axis of sprag 36a. It is contemplated that first link 22a may include two link plates disposed on opposite sides of inner race 34 and that each of the two link plates may include passageways associated with second fluid path 40. The above description of sprag 36a is equally applicable to each of plurality of sprags 36.

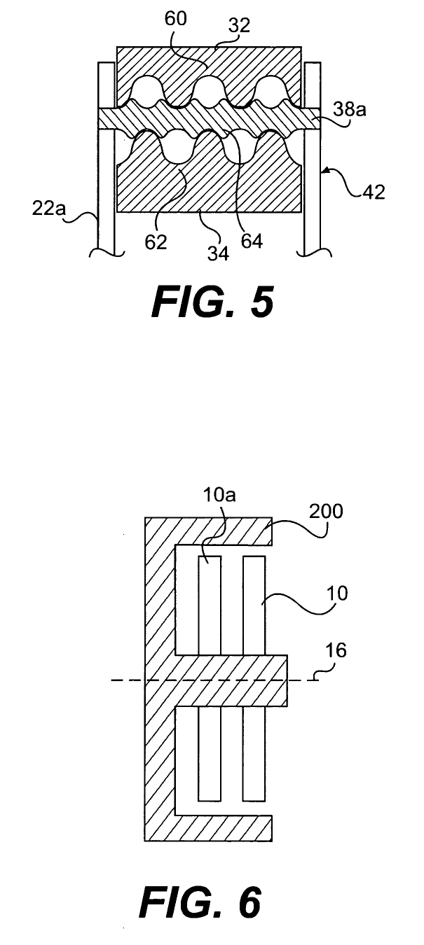

FIG. 5 illustrates an exemplary bearing 38a. Bearing 38a may include a plurality of ridges 64 on an outer surface thereof. Ridges 64 may be complementary in shape and configured to engage grooves 60, 62 of outer and inner races 32, 34, respectively. Bearing 38a may be rotatably supported with respect to bearing cage 42 and may be configured to rotatably support outer and inner races 32, 34 with respect to one another. It is contemplated that ridges 64 may include any shape, e.g., arcuate, triangular, square, or rectangularly stepped, and may be regularly or irregularly spaced with respect to an axis of bearing 38a. It is also contemplated that the quantity of ridges 64 may be approximately twice the quantity of ridges 56, 58 of sprag 36a. The above description of bearing 38a is equally applicable to each of plurality of bearings 38.

FIG. 6 illustrates motor 10 operatively connected to an output 200. Specifically, motor 10 may be operatively connected to output 200 via a fixed connection between a radial center portion of output wheel 12. Additionally, another motor 10a may be similarly operatively connected to output 200. Motor 10a may be substantially similar to motor 10 and may be similarly configured to provide rotary motion to output 200. As such, fluid motors 10, 10a may, together, establish a combined motor configured to impart rotary motion to output 200. It is contemplated that any quantity of motors 10, 10a may be operatively connected to output 200 and may or may not be connected in series with each other. It is also contemplated that at least two motors 10, 10a may be operatively connected to output 200 to provide both forward and reverse movement of output 200 as is explained below.

### INDUSTRIAL APPLICABILITY

The disclosed motor may be applicable to any system where rotary motion may be desired. Motor 10 may convert hydraulic potential energy into mechanical kinetic energy and may be configured to provide a localized rotary motion to one or more components. The operation of motor 10 is explained below.

Referring to FIGS. 1 and 6, motor 10 may be operatively connected to output 200 and configured to rotate output 200. For example, output 200 may be a gear, sprocket, axle, wheel, or other output device connected to motor 10 via any suitable connection, e.g., directly meshing gear teeth, a belt, or a direct fixed connection. As such, motor 10 may be configured to rotate output 200 in a first or clockwise direction and motor 10a may be configured to rotate output 200 in a second or counter-clockwise direction. Additionally, motors 10, 10a may also be configured to rotate output 200 in drive or retarding load conditions.

Referring to FIGS. 1-4, pressurized fluid may be selectively communicated from hydraulic system 18 toward first fluid chamber 24a to displace first actuator 24 in an extending direction. Additionally, pressurized fluid communicated to first fluid chamber 24a may be communicated along first, second, and third fluid paths 26, 40, 54 to plurality of actuators 44 of sprag 36a. Plurality of actuators 44 may extend and rotate sprag 36a about sprag axis 48 and affect the long dimension thereof to fixedly engage outer and inner races 32, 24 and substantially lock outer and inner races 32, 34 together. With first sprag 36a locking outer and inner races 32, 34 together, extension of first actuator 24 may urge toothed wheel 20 in a substantially linear motion. That is, actuator 24 may extend and affect third link 22c to similarly extend in a substantially linear motion. Movement of third link 22c may affect second link 22b to pivot about pivot 30 and transfer linear movement of third link 22c to movement of first link 22a that may be substantially tangential to the circumference of output wheel 12. Movement of first link 22a may affect toothed wheel 20 to move in a substantially similar tangential movement.

Pressurized fluid may also be communicated to second actuator 22d affecting an extension thereof. An extension of second actuator 22d may urge first link 22a in a direction away from the connection point between second and third links 22b-c. Because toothed wheel 20 may be configured to selectively engage output wheel 12 and, thus, may be located adjacent the circumference thereof, urging first link 22a away from the connection point between second and third links 22b-c may ensure toothed wheel 20 engages output wheel 12 when pressurized fluid is selectively communicated to first fluid chamber 24.

Movement of toothed wheel 20 may be transferred to output wheel 12 at a circumference thereof establishing a substantially rotary movement about axis 16. Because sprag 36a locks outer and inner races 32, 34 together, toothed wheel 20 is substantially prohibited from rotating with respect to first link 22a. Because toothed wheel 20 is prohibited from rotating and because the profiled circumference of toothed wheel is operatively connected to the profiled circumference of output wheel 12, the substantially tangential movement of toothed wheel 20 is transferred to output wheel 12 and output wheel 12 rotates about axis 16. As such, first displacement assembly 14a may cause output wheel to rotate about axis 16.

The pressurized fluid previously supplied to first fluid chamber 24a may selectively be drained therefrom. As such, spring 28 may urge linkage 22 and first actuator 24 to a non-extended position. Additionally, pressurized fluid previously supplied to sprag 36a via first, second, third fluid paths 26, 40, 54 may be similarly relieved and springs 46 may rotate sprag 36a to rotate about sprag axis 48 and affect the short dimension of sprag 36a to unlock outer and inner races from one another.

Referring to FIG. 1, pressurized fluid may be selectively supplied to an adjacent one of displacement assemblies 14 with respect to first displacement assembly 14a. As such, the adjacent one of displacement assemblies 14 may similarly cause output wheel 12 to rotate about axis 16. Thus, first displacement assembly 14 may rotate output wheel 12 a first degree of rotation about axis 16, e.g., 40 degrees, and the adjacent one of displacement assemblies 14 may rotate output wheel 12 about axis 16 a second degree of rotation, e.g., 40 degrees. It is contemplated that subsequent operation of adjacent displacement assemblies 14 may rotate output wheel 12 subsequent degrees of rotation to achieve any number of degrees of rotation of output wheel 12, e.g., 360 degrees. It is also contemplated that the direction that first actuator 24 extends with respect to axis 16 may establish the rotary movement of output wheel 12 as either clockwise or counter-clockwise. For example, if first fluid actuator 24 is configured to extend in a counter-clockwise direction (as illustrated in FIG. 1), output wheel 12 may rotate about axis 16 in a counter-clockwise direction. It is further contemplated that to achieve a clockwise rotation of output wheel 12 about axis 16, first fluid actuator 24, linkage 22, and toothed wheel 20, i.e., displacement assembly 14 may be oriented with respect to output axis 16 in a substantially mirror image arrangement than that illustrated in FIG. 1.

The timing of selectively supplying and draining pressurized fluid to and from displacement assemblies 14 may affect the rotation of output 12. By draining pressurized fluid from first fluid actuator 24, as described above, second fluid actuator 22d may not urge toothed wheel 20 away from the connection point between second and third links 22b-c. As such, first link 22a and toothed wheel 20 may be allowed to pivot about the connection point between first and second links 22a-b. Such a rotation or toothed wheel 20 may be affected as output wheel 12 rotates a second degree of rotation about axis 16 affected by, for example, the adjacent one of displacement assemblies 14. That is, because the circumference of output wheel 12 and the circumference of toothed wheel 20 may be profiled, e.g., having a ratchet tooth profile, rotation of output wheel 12 by adjacent ones of displacement assemblies 14 might be resisted if toothed wheel 20 was not allowed to un-mesh from output wheel 12. It is contemplated that toothed wheel 20 may rotate about the connection point between first and second links 22a-b as a function of the profiled circumference of output wheel 12 and toothed wheel 20. For example, if output wheel 12 and toothed wheel 20 each have a ratchet tooth profile, e.g., as illustrated in FIG. 2, toothed wheel 20 may be configured to rotate and permit a subsequent ratchet teeth of output wheel 12 to pass toothed wheel 20.

Additionally, outer race 32 of toothed wheel 20 may rotate with respect to inner race 34 and first link 22a when pressurized fluid is not selectively supplied to sprags 36. Bearings 38 may support and allow outer race 32 to rotate with respect to inner race 34 which may be fixedly connected to first link 22a. As such, the ability of outer race 32 to so rotate may further allow adjacent ones of displacement assemblies 14 to affect subsequent rotation of output wheel 12. It is contemplated that rotation of outer race 32 with respect to both inner race 34 and first link 22a may also allow a subsequent portion of the profiled circumference of toothed wheel 20 to engage output wheel 12. For example, if toothed wheel 20 includes a ratchet tooth profile, a subsequent ratchet tooth may engage output wheel 12 during a subsequent operation of first displacement assembly 14a as compared to a ratchet tooth that may have engaged output wheel during a previous operation of first displacement assembly 14.

Selectively omitting the operation of one or more of displacement assemblies 14 during actuation sequences may provide an adjustability of the rotational output of output wheel 12 and thus motor 10. For example, actuating all of displacement assemblies 14 may provide a maximum rotational output torque of motor 10, selectively omitting one or more of displacement assemblies 14 may provide decreased rotational output torque of motor 10, and actuating only one of displacement assemblies 14 may provide a minimum output torque of motor 10. It is contemplated that the rotational speed of motor 10 may inversely correspond to the rotation output torque of motor 10. For example, if motor 10 includes nine displacement assemblies 14, selectively omitting one or more displacement assemblies 14 may provide nine step change ratios, e.g., 9:9, 8:9, 7:9, 6:9, 5:9, 4:9, 3:9, 2:9, 1:9, each corresponding to the rotational degree each one of displacement assemblies 14 may rotate output wheel 12 and the combined rotational output, e.g., torque and speed, for an actuation sequence. It is also contemplated that the different step change ratios may be achieved by selectively not supplying pressurized fluid to one or more of the first fluid actuators, e.g., first fluid actuator 24, operatively associated with respective ones of displacement assemblies 14 during a particular actuation sequence. It is also contemplated that the various step changes of motor 10 may further be varied by adjusting the displacement of the first fluid actuators, e.g., first fluid actuator 24, operatively associated with respective ones of displacement assemblies 14 via hydraulic system 18, potentially providing a continuously variable output of motor 10. It is further contemplated that the various step changes of motor 10 may further be varied by providing one or more additional output wheels having different profiles than the profile of output wheel 12, e.g., output wheel 12 may have a given number of ratchet teeth and one or more additional output wheels may have more or less teeth. Output wheel 12 and the additional output wheels may be selectively engaged and disengaged with displacement assemblies by being shifted respect to displacement assemblies 14 and/or by shifting displacement assemblies 14 with respect to the additional output wheels.

Referring to FIG. 6, multiple motors 10, 10a may be connected to output 200 to provide both clockwise and counter-clockwise rotation to output 200 and/or to increase the continuousness of rotary motion delivered thereto. Specifically, motor 10 may be configured as a clockwise motor and motor 10a may be configured as a counter-clockwise motor. For example, selectively supplying pressurized fluid the one or more displacement assemblies 14 of a respective one of motors 10, 10a may enable output 200 to rotate in either the clockwise or counter-clockwise direction. Additionally, the timing of selectively supplying pressurized fluid to one or more displacement assemblies 14 of respective motors 10, 10a may be staggered to further increase the continuousness of the rotary motion delivered to output 200. For example, a first displacement assembly of motor 10 may be actuated to rotate the output wheel thereof, a first displacement assembly of motor 10a may be actuated to rotate the output wheel thereof, and the sequence repeated for subsequent displacement assemblies. It is contemplated that first displacement assembly of motor 10a may be actuated any time after the actuation of the first displacement assembly of motor 10. It is also contemplated that any number of motors 10, 10a may be operatively connected to output 200 and may be arranged in any suitable manner, such as one or more clockwise motors and/or one or more counter-clockwise motors. It is also contemplated that motors 10, 10a may be actuated in any sequence and adjusted according to any desired drive directions, speeds, and/or loads with respect to output 200. It is also contemplated that rotational energy may be recoverable by operatively connecting one or more of motors 10, 10a and/or output 200 to an energy storage device such as, for example, an accumulator, a flywheel, a generator, a step change gear box, and/or other energy storage device known in the art. It is further contemplated that if output 200 is operatively connected to a gear box, motors 10, 10a may selectively provide rotational energy to the one or more gear ratios to increase and/or decrease the output rotational energy thereof the gearbox, potentially establishing a continuously variable change ratio for the output of the gear box.

Because sprags 36 may be hydraulically actuated, they may actively lock outer and inner races 32, 34 together potentially reducing the occurrence of lost motion inherently associated with passively actuated sprags. Additionally, because sprags 36 may be hydraulically actuated, and may include ridges 56, 58 staggered with respect to one another, they may provide increased frictional engagement with outer and inner races 32, 34. Furthermore, because bearings 38 include ridges 64 complimentary to the staggered grooves 60, 62, they may rotatably support outer and inner races 32, 34 when sprags 36 are not actuated. It will be apparent to those skilled in the art that various modifications and variations can be made to the disclosed one-way sprag and bearing system. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A sprag comprising:
an integral body having an oblong cross sectional circumference;
at least one actuator configured to selectively rotate the body about an axis in a first direction; and
at least one spring configured to bias the body to rotate about the axis in a second direction.

2. The sprag of claim 1, further including:
a fluid passageway disposed within the body and configured to communicate pressurized fluid toward the at least one actuator.

3. The sprag of claim 1, wherein:
the at least one actuator is a plurality of hydraulic actuators; and
the plurality of hydraulic actuators selectively rotate the sprag about the axis as a function of pressurized fluid selectively supplied to the plurality of hydraulic actuators.

4. The sprag of claim 1, wherein:
the body is rotatably supported within a bearing cage;
the bearing cage includes a first tab; and
the at least one actuator selectively provides a force against the first tab to selectively rotate the sprag.

5. The sprag of claim 4, wherein:
the bearing cage includes a second tab; and
the at least one spring provides a force against the second tab to bias the sprag to rotate.

6. The sprag of claim 1, wherein:
the oblong profile includes at least a first dimension and at least a second dimension, the first dimension being longer than the second dimension;
rotation of the sprag in the first direction aligns the first dimension between an inner and an outer race to substantially lock the inner and outer races together; and
rotation of the sprag in the second direction aligns the second dimension to not substantially lock the inner and outer races together.

7. The sprag of claim 1, further including a plurality of ridges on a longitudinal outer surface of the body.

8. A bearing comprising:
a body having a plurality of ridges on outer longitudinal surface and being configured to engage an inner and outer race;
the inner race having a first plurality of grooves on an outer surface thereof;
the outer race having a second plurality of grooves on an inner surface thereof; and
the quantity of the plurality of ridges being at least twice the quantity of the first plurality of grooves.

9. The bearing of claim 8, wherein the first plurality of grooves are offset with respect to the second plurality of groves.

10. The bearing of claim 8, wherein a first one of the plurality of ridges is aligned with a first one of the first plurality of grooves and not aligned with a first one of the second plurality of grooves.

11. The bearing of claim 10, wherein a second one of the plurality of ridges is aligned with a second one of the second plurality of grooves and not aligned with a second one of the first plurality of grooves.

12. A system comprising:
an inner race member and an outer race member, the inner race member spaced apart from the outer race member;
a plurality of sprags disposed between the inner and outer race members and configured to selectively and substantially lock the inner and outer race members together as a function of pressurized fluid being selectively supplied to the plurality of sprags.

13. The system of claim 12, wherein each of the plurality of sprags includes:
a profiled outer longitudinal surface; and
an oblong cross sectional circumference.

14. The system of claim 13, wherein:
an outer surface of the inner race member includes a first plurality of grooves;
an inner surface of the outer race member includes a second plurality of grooves; and
the profiled outer longitudinal surface includes a plurality of ridges configured to be complimentary to both the first and second plurality of grooves.

15. The system of claim 14, wherein:
the profiled outer longitudinal surface includes a first plurality of ridges on a first side of the sprag and a second plurality of ridges on a second side of the sprag substantially opposite the first side; and
the first plurality of ridges are offset from the second plurality of ridges.

16. The system of claim 12, further including a plurality of bearings disposed between the inner and outer race members and interspaced among the plurality of sprags.

17. The system of claim 12, further including a bearing cage configured to rotatably support the plurality of sprags having at least one fluid passageway configured to fluidly communicate pressurized fluid to the plurality of sprags.

18. The system of claim 12, wherein each of the plurality of sprags are rotatably supported by a bearing cage and include:
at least one hydraulic actuator configured to selectively receive pressurized fluid and rotate the sprag with respect to the bearing cage in a first direction.

19. The system of claim 12, wherein the inner and outer races are substantially cylindrical and the plurality of sprags enable the inner and outer race members to substantially not rotate with respect to one another as a function of the pressurized fluid being selectively supplied to the plurality of sprags.

20. The system of claim 12, wherein:
the outer race member has a profiled outer surface configured to selectively engage an output member; and
the plurality of sprags are configured to transfer a movement applied to the inner race member to the outer race member and enable the outer race member to impart the transferred movement to the output member.
